(19) United States
(12) Patent Application Publication
(10) Pub. No.: US 2009/0161243 A1
(43) Pub. Date: Jun. 25, 2009

(54) Monitoring Disk Drives To Predict Failure

(76) Inventors: Ratnesh Sharma, Fremont, CA (US); Chandrakant Patel, Fremont, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/254,941

(22) Filed: Oct. 21, 2008

Related U.S. Application Data
(60) Provisional application No. 61/016,109, filed on Dec. 21, 2007.

(51) Int. Cl. G11B 27/36

(52) U.S. Cl. 360/31; G9B/27.052

(57) ABSTRACT

Embodiments include methods, apparatus, and systems for monitoring disk drives to predict failure. One embodiment includes a disk drive having a plurality of different types of sensors that sense events over a lifetime of the disk drive. Data from the events is aggregated to predict when the disk drive will fail.

### CROSS-REFERENCE TO RELATED APPLICATION

The present application claims priority from provisional application Ser. No. 61/016,109, filed Dec. 21, 2007, the contents of which are incorporated herein by reference in their entirety.

### BACKGROUND

Hard disk drives provide large amounts of inexpensive storage that is used in a multitude of electronic devices ranging from computers to digital cameras and mobile phones. The convenience and affordability of hard drives enable commercial viability of electronic devices that require vast amounts of storage.

Hard disk drives can unexpectedly fail without providing the user with any notification. When this situation occurs, the user can lose all data on the disk drive.

Electronic devices utilizing hard disk drives and users of such devices will benefit from methods and apparatus for reliably predicting failure of a hard disk drive before the failure actually occurs.

### BRIEF DESCRIPTION OF THE DRAWINGS

FIG. 1 is a cut-away side view of a hard disk drive having a plurality of sensors in accordance with an exemplary embodiment.

FIG. 2 is a system in accordance with an exemplary embodiment.

FIG. 3 is a flow diagram for predicting failure of a hard disk drive in accordance with an exemplary embodiment.

FIG. 4 is a block diagram of a computer in accordance with an exemplary embodiment.

### DETAILED DESCRIPTION

Embodiments are directed to apparatus systems, and methods to predict failure of drive mechanisms, such as hard disk drives, in a computer or electronic device. In one embodiment, a method monitors drive mechanisms and predicts failure of the drive mechanisms before such a failure actually occurs. Exemplary embodiments utilize a combination of various sensors, such as optical, piezoelectric, and strain sensors, to monitor performance of drive mechanisms, including integrity of the drive motor, bearing, platter, and actuator.

In one embodiment, sensors monitor the drive mechanisms over a lifetime of the drives. The sensors detect the accumulated effect of different stress factors, and these factors are used to provide a reliable prediction or estimation of failure or life expectancy of the drive mechanisms. By way of example, one embodiment monitors the accumulated effect of long term low intensity and short term high intensity stresses. Such effects cannot be detected by sensors that focus on active short term correction. Evaluation of both types of stresses provides reasonable indications for degradation and a root cause determination of an actual or predicted failure.

One embodiment uses multiple optical, piezoelectric, and strain sensors to monitor and detect the integrity of hard drives during the lifetime of the drive. The data from these different sensors is aggregated to determine what has happened to the hard drives during their lifetime. The sensed data includes a record of time at which an incident or event occurs and duration of the incident or event. The data is transmitted or provided to an assessment module that predicts a life expectancy of the drive.

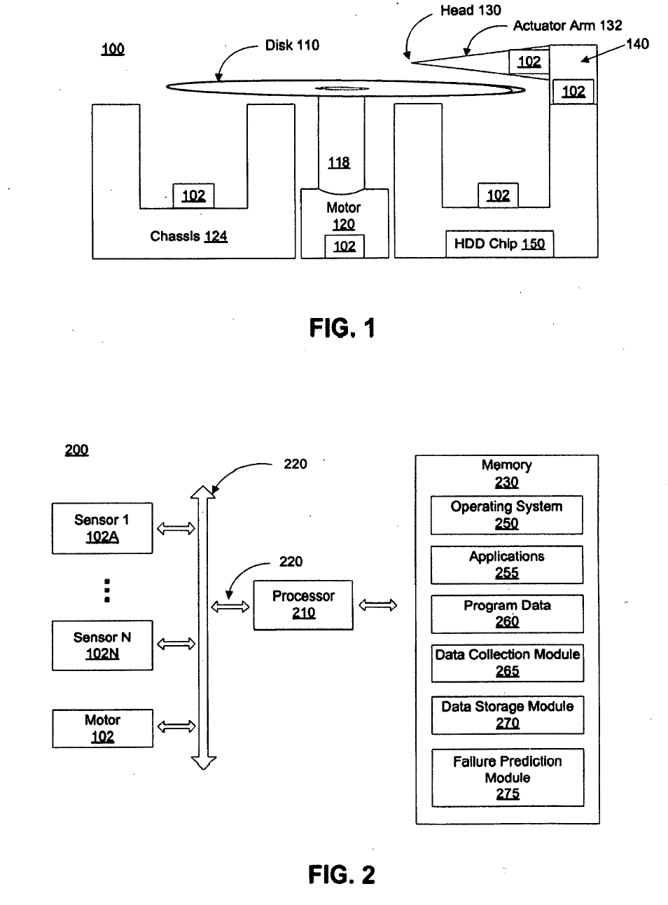

FIG. 1 illustrates a partial side view of a drive 100 having a plurality of sensors 102. In one embodiment, the drive 100 is a hard disk drive for writing data to and/or reading data from a disc 110. For example, exemplary embodiments of the disc 110 include a magnetic disc, a compact disc (CD), a digital video disc (DVD), and other storage media. For illustration, the drive mechanism is provided as a hard disk drive (HDD). The drive 100, however, is depicted as a disc drive for illustration purposes only, and persons having ordinary skill in the art will appreciate that the drive 100 can be other types of electronic devices for storing data to or reading data from any form of non-volatile storage media.

The hard disk drive 100 stores information on the disk which is mounted to a spindle 118. A motor 120 attaches to one end of the spindle 118 to rotate the spindle and disk 110 or platter. The motor 120 and spindle 118 are mounted to a body or chassis 124.

To read and write to the surface of the disk 110, the hard disk drive 100 uses a small electro-magnet assembly or head 130 located on the end of an actuator arm 132. Typically, there is one head for each platter surface on the spindle 118. The disks 110 are spun at a very high speed to allow the head 130 to move quickly over the surface of the disk. Towards the other end of the actuator arm 132 is a pivot point 140 which moves the head.

Embodiments in accordance with the invention utilize multiple different types of sensors 102 to predict failure and life expectancy for the hard disk drive 100. By way of illustration, one or more sensors are attached to the chassis 124, the spindle 118, the motor 120, the actuator arm 132, and other parts of the hard disk drive.

Exemplary embodiments use different types of sensors 102 to gather data during the life of the disk drive. While optical sensors monitor instantaneous alignment, piezoelectric sensors track the vibration of critical parts. Strain sensors monitor any shocks or major shifts that occur over time due to mishandling or operating conditions. Distributed feedback (DFB) lasers operating in the 3rd transmission window, used for fiber channel connectivity, are used to track deviations (for example, deviations on the order of 1550 nm). An array of optical sensors/detectors is used to track large deviations. Smaller deviations are monitored by attenuation of signal. Such emitter-detector pairs are mounted on the chassis or on the various parts of the drive assembly, such as the actuator arm, head or spindle. Hard drive speed changes, platter surface imperfections, rotational wobble, head-platter clearance, and axial and rotational runout are some of the parameters that can be monitored. By way of example, the runout can be classified as repetitive runout or non repetitive runout. Repetitive runout at a given frequency implies a permanent defect at a given location and therefore used to modify lifetime of the drive.

Piezoelectric sensors mounted on the head 130 detect any uncharacteristic vibration during normal transactions. Strain rosettes or gages can be used to monitor bulk or accumulated deviations during total lifetime of the hard disk drive. Benchmark readings can be calibrated during manufacture for comparison.

As additional examples, integrated circuit (IC) sensors (transistors) can also be integrated on the actuator arm 132 or head 130 to monitor temperature for thermal transients and shocks. Additional circuitry can be used to record the maximum temperature seen by the drive for reliability assessment and root cause analysis. Non-contact capacitance sensors can used to detect run-out of the disc stack. Acoustic emission sensors can be used to detect interference between rotating parts.

By way of further example, these sensors include, but are not limited to, piezoelectric sensors for sensing vibration, strain sensors for sensing shock, and optical sensors for sensing alignment. For instance, sensors on the actuator arm 132 and motor 130 detect vibration while the disk drive is reading and writing data to the disk 110. Abnormal vibrations are sensed and used as a factor to determine the life expectancy of the disk drive or to predict failure. As another example, one or more of the sensors can be an accelerometer that detects movement (for example, movement of the actuator arm 132). The detected movement can include information related to the speed or direction a component is moving.

Sensed data is transmitted or sent to a processing and storage device. In one embodiment, the hard disk drive 100 includes chip 150 located inside or integrated to the drive. In another embodiment, the sensed data is transmitted to a processing and storage device external to the hard disk drive (for example, a computer). Thus, the processor can be located within the drive 100 or external to the drive 100.

Data from the sensors is used to monitor the accumulated effect of stress factors like temperature, mechanical stress (for example, vibration, shock, etc.), and/or corrosion on the mechanical integrity of the hard drive. Sensor data is also used to predict the lifetime of the device and even create a “history” of the device to evaluate the implications for liability purposes. This history includes a record or log of the sensed data.

FIG. 2 illustrates a system 200 for analyzing sensed data and predicting drive failure. It should be understood that the following description of the block diagram 200 is but one manner of a variety of different manners in which such a system 200 can be configured. In addition, it should be understood that the system 200 can include additional components and that some of the components described herein can be removed and/or modified without departing from the scope of the system 200. For instance, the system 200 can include any number of sensors, memories, processors, etc., as well as other components.

As shown, the system 200 includes the processor 210 coupled via buses or communication links 220 to sensors 102 (shown as 102A to 102N), motor 120, and memory 230. The processor 210 performs various functions in either the drive 100 or the system 200. By way of example, the processor 210 includes a microprocessor, a micro-controller, an application specific integrated circuit (ASIC), and the like, configured to perform various processing functions.

The memory 230 can be separate from the processor 210 or form part of the processor without departing from a scope of the system 200. Generally speaking, the memory 230 provides storage of software, algorithms, and data. By way of example, the memory 230 stores one or more of an operating system 250, application programs 255, program data 260, and the like and is implemented as a volatile and/or non-volatile memory, such as DRAM, EEPROM, MRAM, flash memory, and the like. In addition, or alternatively, the memory 230 can include a device configured to read from and write to a removable media, such as, a floppy disk, a CD-ROM, a DVD-ROM, or other optical or magnetic media.

The memory 230 is also depicted as including a data collection module 265, a data storage module 270, and a failure prediction or an assessment module 275. The processor 210 invokes or otherwise implements these modules to analyze the drive 100 and/or the system 200 to predict failure and life expectancy.

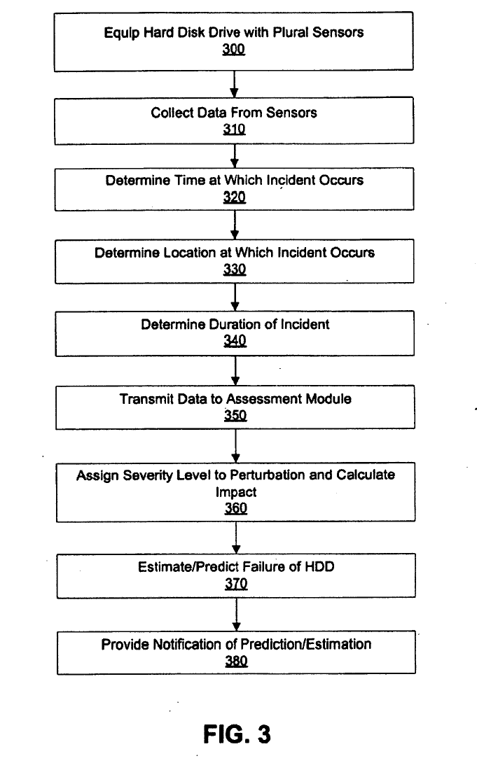

The data collection module 265 collects or receives data from the sensors 102 and performs calculations or algorithms to convert the input data in a suitable form for analysis. For example, the collection module 265 can perform fast Fourier transforms to calculate the frequencies of vibration. The collected data is then sent to the data storage module 270 for storage. The processor 210 invokes the failure prediction module 275 to execute data analysis and failure prediction (for example, as discussed in FIG. 3).

FIG. 3 is a flow diagram for predicting failure or life expectancy of a hard disk drive in accordance with an exemplary embodiment. According to block 300, the hard disk drive is equipped with plural sensors. Exemplary embodiments for such sensors are discussed in connection with FIGS. 1 and 2.

According to block 310, data is collected from the plural sensors. The collected data is stored in memory at the hard disk drive or at a location remote to the drive (for example, in memory of a computer in communication with the drive).

According to block 320, determine the time at which an incident occurs. A clock is used to record a time and/or date when sensed events occur. Such events include, but are not limited to, vibrations, temperature, shock, alignment, etc. and depend on the number and type of sensors being utilized to sense events.

According to block 330, determine a location at which an incident occurs. Since plural sensors simultaneously record events, sensed data is correlated with the particular sensor sensing this data. The particular sensor and location of that sensor on or in the hard disk drive is stored.

According to block 340, determine a duration for which an incident occurs. A clock is used to record the duration or length of time for each event. Such events include, but are not limited to, vibrations, temperature, shock, alignment, etc. and depend on the type of sensors being utilized to sense events.

According to block 350, sensed data is sent or transmitted to an assessment or failure prediction module. The module can be physically located in the hard disk drive or at a location remote to the drive (for example, in memory of a computer in communication with the drive).

According to block 360, the assessment module assigns a severity level to the perturbation and calculates the cumulative impact on the lifetime of the device. In case the severity is high and the cumulative impact is great, the drive can initiate corrective action like spin down or reduce access speed even before notification.

According to block 370, estimate or predict failure or life expectancy of the hard disk drive. The multiple sensors monitor events or stresses that can shorten the lifetime or expedite failure of the hard disk drive. Data from these sensors is continuously collected and accumulated to estimate when in time the hard disk drive will fail. Certain events increase or expedite failure of the drive. Such events include, but are not limited to, exposure to abnormal vibration, excess heat, mechanical or electrical shock, wear or misalignment of components, etc.

According to block 380, the estimation of life expectancy or prediction of failure is provided through a notification. For example, the hard disk drive automatically notifies a user how long in time before the hard disk drive is expected to fail. Notification can be provided with a variety of methods, such as through an audible or visual alarm, email, text message, menu selection, screen display, etc.

In one exemplary embodiment, the life expectancy (for example, provided to the user in minutes, hours, days, etc.) is continuously or periodically updated. As new data is sensed, this data is used to re-calculate the life expectancy. For instance, as new events occur that shorten the life expectancy or increase the likelihood of an upcoming failure, these events are used to re-calculate a new life expectancy or estimation of failure. This information is conveyed to a user or electronic device.

Upon receiving notification, a user can take measures to ensure that data on the hard disk drive is saved or backed up. Further, the user can repair or replace the hard disk drive before the failure actually occurs.

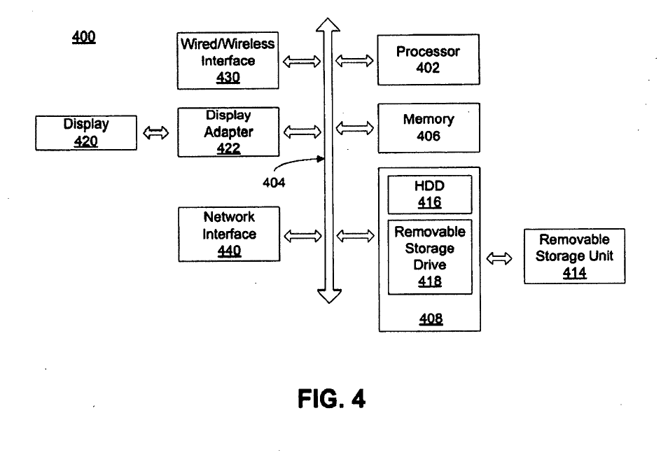

FIG. 4 illustrates an exemplary block diagram of a general purpose computing system 400 that implements methods in accordance with exemplary embodiments. The computing system 400, or any part thereof, can be located within, or external to, the drive 100 and/or the system 200 discussed in FIGS. 1 and 2. It should be understood that components shown in FIG. 4 can be added or removed from the computing system 400 without departing from exemplary embodiment.

The computing system 400 includes one or more processors, such as processor 402 that provides an execution platform for executing software. By way of example, the processor can be a general-purpose processor, such as a central processing unit (CPU) or any other multi-purpose processor or microprocessor.

Commands and data from the processor 402 are communicated over a communication bus 404. The computing system 400 also includes a main memory 406 where software is resident during runtime, and a secondary memory 408. The secondary memory 408 can also be a computer readable medium (CRM) that stores the software programs, applications, or modules for implementing methods in accordance with exemplary embodiments. The secondary memory 408 (and an optional removable storage unit 414) includes, for example, a hard disk drive 416 and/or a removable storage drive 418 representing a floppy diskette drive, a magnetic tape drive, a compact disk drive, etc., or a nonvolatile memory where a copy of the software can be stored. Thus, the main memory 406 or the secondary memory 408, or both, can include one or more hard disk drives as discussed with exemplary embodiments.

In one exemplary embodiment the computing system 400 includes a display 420 connected via a display adapter 422, a wired or wireless interface 430, and a network interface 440. The network interface 440 is provided for communicating with networks such as a local area network (LAN), a wide area network (WAN), or a public data network such as the Internet.

Exemplary embodiments are applicable to a variety of electrical and mechanical devices, such any rotary or moving parts in or apart from a data center. By way of example, such devices include, but are not limited to, cooling fans, pumps, motors, bearings, platters, actuators, valves, etc.

In one exemplary embodiment, data is collected and stored over a lifetime of a device to build a profile. The collected historical data is used for various purposes, such as notifying a user before the device or a component will fail, providing corrective action to improve integrity or performance of the device (for example, automatically slow down or turn off a moving part), providing feedback during product testing so as to generate MTBF data for product development, warning a computer user that they should replace a component (for example, replace a drive before data loss occurs), providing knowledge extraction (for example, testing or analysis of components), and providing migration data.

In order to sense the collected data, one or more sensors can be placed on or near the device or component being monitored. For example, a series of sensors are installed in a data center environment and used to analyze sound, temperature, energy consumption in a facility to predict reliability. In one exemplar embodiment, collected data and/or analysis is provided as a web service monitoring system for customers with a minimum of capital outlay (i.e. just one sensor package). In another exemplary embodiment, an event driven aggregation is proposed so that there is on-demand monitoring rather than a web-based display. Only significant events are communicated and pertinent data is logged which enable quick extraction of useful knowledge. Further, exemplary embodiments can be used to reduce latency associated with mirroring and the redundancy required to improve storage availability.

In one exemplary embodiment one or more blocks or steps discussed herein are automated. In other words, apparatus, systems, and methods occur automatically. As used herein, the terms “automated” or “automatically” (and like variations thereof) mean controlled operation of an apparatus, system, and/or process using computers and/or mechanical/electrical devices without the necessity of human intervention, observation, effort and/or decision.

As used herein, the word “lifetime” means the duration of the existence of the device. For example, the lifetime of the drive means the duration of time of the existences of the drive. Further, as used herein, the term “life expectancy” means the life span of operation for the device. For example, the life expectancy of the drive means the life span of operation for the drive. In other words, life span means how long the drive is operational.

The methods in accordance with exemplary embodiments of the present invention are provided as examples and should not be construed to limit other embodiments within the scope of the invention. For instance, blocks in diagrams or numbers (such as (1), (2), etc.) should not be construed as steps that must proceed in a particular order. Additional blocks/steps may be added, some blocks/steps removed, or the order of the blocks/steps altered and still be within the scope of the invention. Further, methods or steps discussed within different figures can be added to or exchanged with methods of steps in other figures. Further yet, specific numerical data values (such as specific quantities, numbers, categories, etc.) or other specific information should be interpreted as illustrative for discussing exemplary embodiments. Such specific information is not provided to limit the invention.

In the various embodiments in accordance with the present invention, embodiments are implemented as a method, system, and/or apparatus. As one example, exemplary embodiments and steps associated therewith are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory and accessed by the processor using the bus. The techniques and methods for embodying software programming code in memory, on physical media, and/or distributing software code via networks are well known and will not be further discussed herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1) A method, comprising:
sensing events of a moving mechanical part using plural different types of sensors;
aggregating data from the events to predict a life expectancy of the moving mechanical part; and
notifying a user of the life expectancy.

2) The method of claim 1 further comprising, sensing the events over a lifetime of a bard disk drive.

3) The method of claim 1 further comprising, recording both a time at which the events occur and a duration for how long the events last.

4) The method of claim 1, wherein the moving mechanical part is a hard disk drive and the events include vibration of the hard disk drive, temperature of the hard disk drive, and shock imparted to the hard disk drive.

5) The method of claim 1 further comprising, detecting interference between the moving mechanical parts.

6) The method of claim 1 further comprising, storing a history of the events during a lifetime of the moving mechanical part.

7) The method of claim 1 further comprising, using the data to predict when in time a hard disk drive will fail.

8) A tangible computer readable medium having instructions for causing a computer to execute a method, comprising:
sensing events with multiple different sensors over a lifetime of a disk drive;
accumulating data from the events to predict when the disk drive will fail; and
notifying a user of a prediction of failure for the disk drive.

9) The computer readable medium of claim 8 further comprising, analyzing sensed data from an optical sensor, a piezoelectric sensor, and a strain sensor over a lifetime of the disk drive.

10) The computer readable medium of claim 8 further comprising, monitoring platter surface imperfections, rotational wobble, and head-platter clearance of the disk drive.

11) The computer readable medium of claim 8 further comprising, analyzing vibration with a piezoelectric sensor mounted on a head of the disk drive.

12) The computer readable medium of claim 8 further comprising, analyzing sensed data from a strain gage that monitors accumulated deviations during a lifetime of the disk drive.

13) The computer readable medium of claim 8 further comprising, analyzing sensed temperature data of the disk drive to determine the prediction of failure.

14) The computer readable medium of claim 8 further comprising, analyzing sensed corrosion of mechanical integrity of the disk drive to determine the prediction of failure.

15) A disk drive, comprising:
a disk;
a head for reading or writing data on the disk; and
a plurality of different types of sensors that sense events over a lifetime of the disk drive, wherein data from the events is aggregated to predict when the disk drive will fail.

16) The disk drive of claim 15 further comprising, a chip that analyzes the data to predict when the disk drive will fail.

17) The disk drive of claim 1S further comprising, an integrated circuit sensor mounted on the head to monitor temperature changes.

18) The disk drive of claim 15, wherein the plurality of different types of sensors include an optical sensor for detecting alignment, a piezoelectric sensor for detecting vibration, and a strain sensor for detecting shock imparted to the disk drive.

19) The disk drive of claim 15 further comprising, a memory for storing both a time at which the events occur and a duration for how long the events last.

20) The disk drive of claim 15 further comprising, an assessment module that analyzes the data to predict when the disk drive will fail.
